(19) United States
(12) Patent Application Publication
(10) Pub. No.: US 2006/0255552 A1
(43) Pub. Date: Nov. 16, 2006

(54) Stunt snow sled

(76) Inventors: Nathan Wojnowski, Salt Lake City, UT (US); Micah A. Wojnowski, Escondido, CA (US)

Correspondence Address: EVERETT D. ROBINSON;Parsons Behle & Latimer, 201 South Main Street, Suite 1800, Salt Lake City, UT, 84145-0898, US

(21) Appl. No.: 11/380,933

(22) Filed: Apr. 30, 2006

Related U.S. Application Data
(60) Provisional application No. 60/676,208, filed on Apr. 30, 2005.

(51) Int. Cl. B62B 15/00

(52) U.S. Cl. 280/18; 280/21.1

(57) ABSTRACT

The inventions relate to devices useful to assist the movement of a person over snow-covered surfaces for travel or pleasure, and more particularly to a sled having a concave body and straight and curved runners for directional control, removable handles and a cushioning liner. Detailed information on various example embodiments of the inventions are provided in the Detailed Description below, and the inventions are defined by the appended claims.

### CROSS REFERENCE TO RELATED APPLICATIONS

This Application claims the benefit of the U.S. Provisional Application No. 60/______ filed Apr. 30, 2005 which is hereby incorporated by reference in its entirety.

### BRIEF SUMMARY

The inventions relate to devices useful to assist the movement of a person over snow-covered surfaces for travel or pleasure, and more particularly to a sled having a concave body and straight and curved runners for directional control, removable handles and a cushioning liner. Detailed information on various example embodiments of the inventions are provided in the Detailed Description below, and the inventions are defined by the appended claims.

### BRIEF DESCRIPTION OF THE DRAWINGS

FIG. 1 depicts the body of a first exemplary sled.

FIG. 2 shows the body of FIG. 1 from the front or back with handles of two types attached thereto.

FIG. 3 shows the body of FIG. 1 from the side with handles of two types attached thereto.

FIG. 4 shows the body of FIG. 1 from above.

FIG. 5 depicts a handle of a first type.

FIG. 6 depicts a handle of second first type.

FIG. 7 depicts a straight runner attachable to a sled body.

FIG. 8 depicts a fastener for attaching the runners depicted in FIGS. 7 and 9.

FIG. 9 depicts a curved runner attachable to a sled body.

FIG. 10 shows a sectional view of the sled body of FIG. 1 with a liner inserted therein.

FIG. 11 shows a sectional view of the sled body of FIG. 1 with runners attached.

FIG. 12 depicts a view of the sled body of FIG. 1 from the top with a liner that incorporates a cushion.

FIG. 13 depicts a second exemplary sled body.

FIG. 14 shows a sectional view of the sled body around the axis marked “B”.

FIG. 15 shows a sectional view of the sled body around the axis marked “A”.

FIG. 16 shows a sectional view of a handle hole in the sled body of FIG. 13.

FIG. 17 shows a sectional view of one groove built into the sled body of FIG. 13.

FIG. 18 shows a sectional view of the bed of the body of FIG. 13.

FIG. 19 shows from five views the body of FIG. 13.

FIG. 20 shows a bottom view of the body of FIG. 13 and showing the relationship of details incorporated to the top.

FIG. 21 shows a bottom view of the sled body of FIG. 13.

FIG. 22 shows from five views a cushion insertable to the sled body of FIG. 13.

FIG. 23 shows from five views the relationship of the cushion of FIG. 22 when inserted into the seld body of FIG. 13.

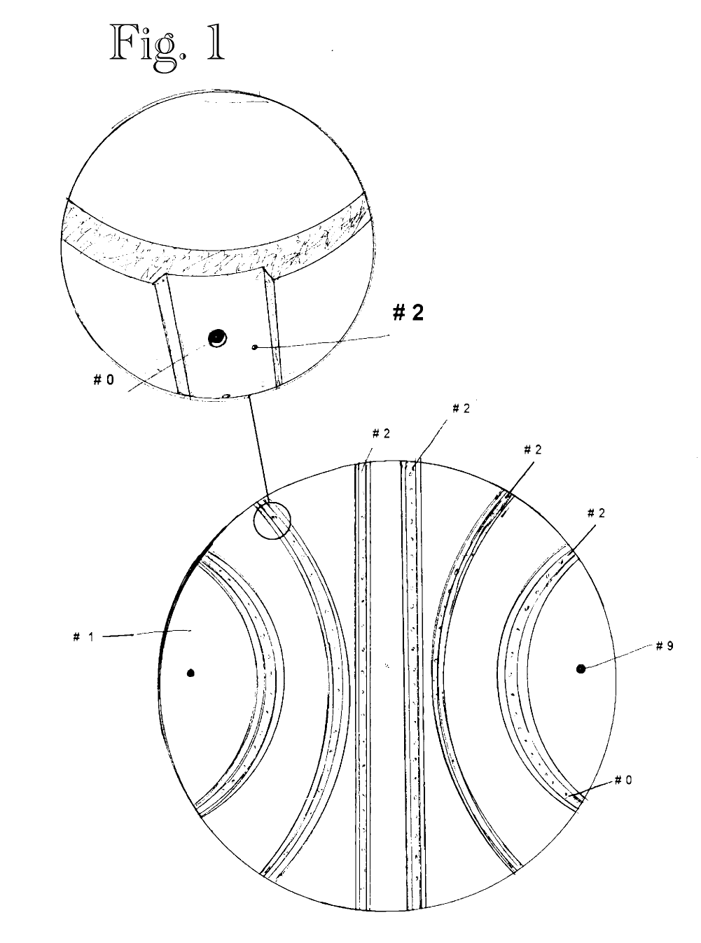

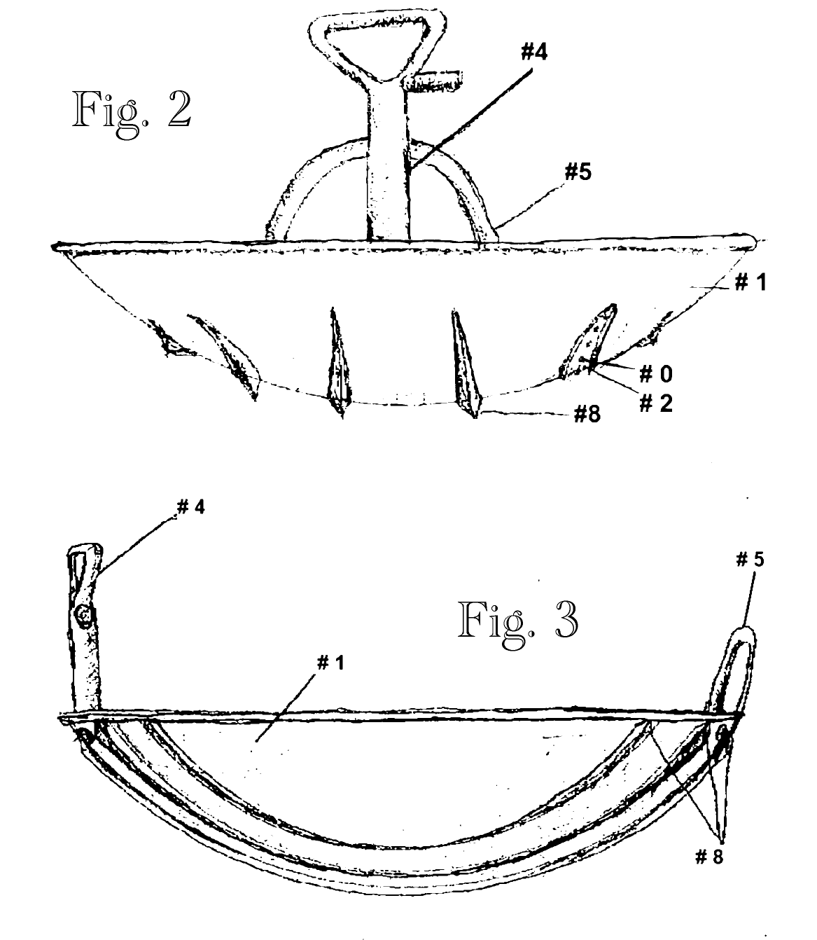

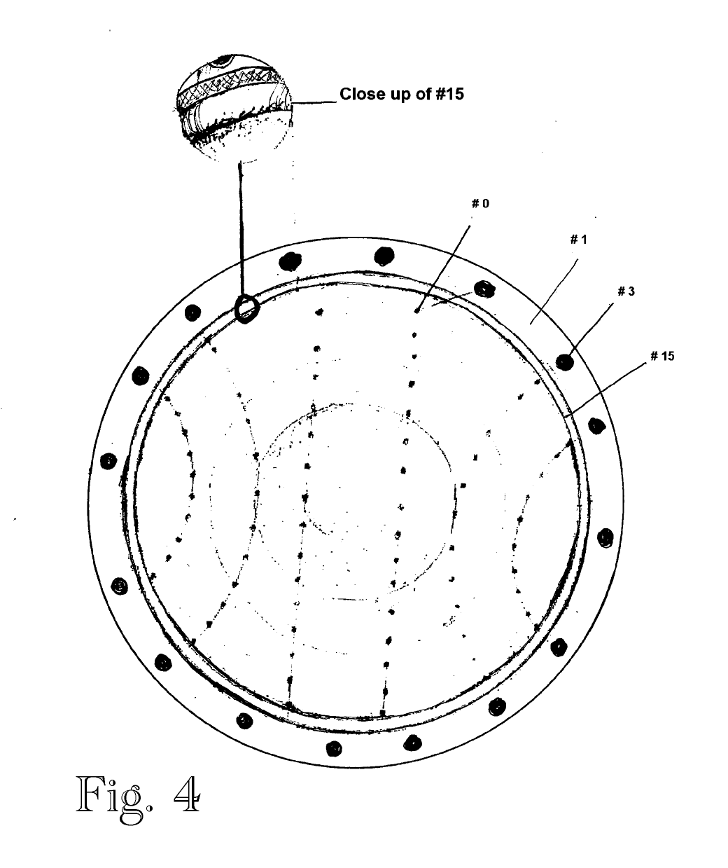

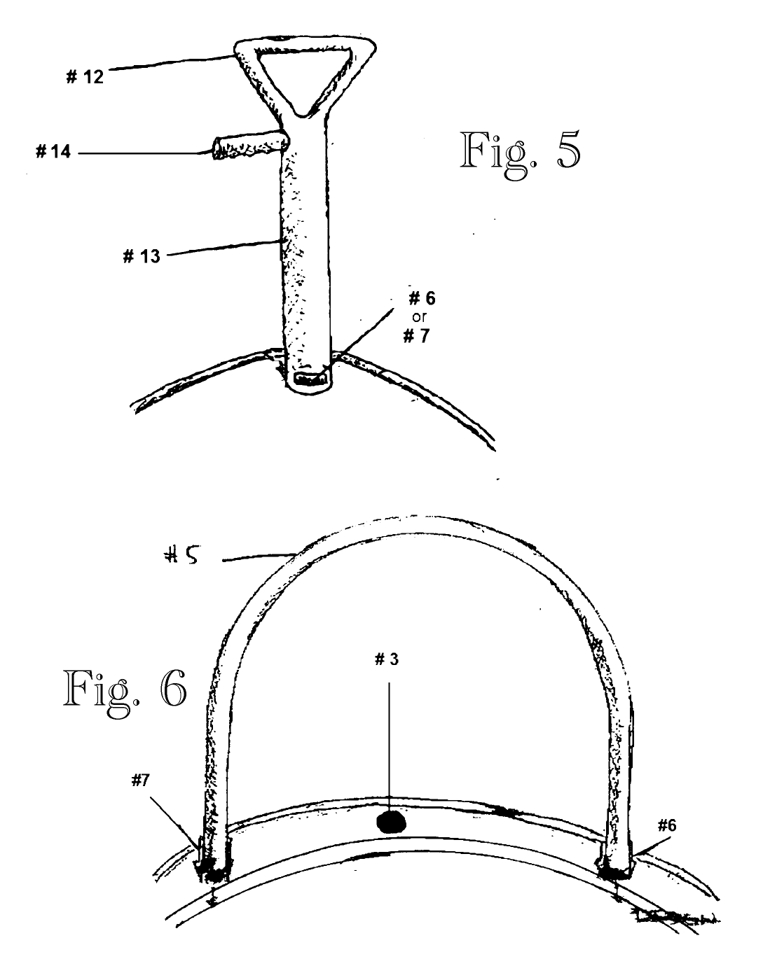

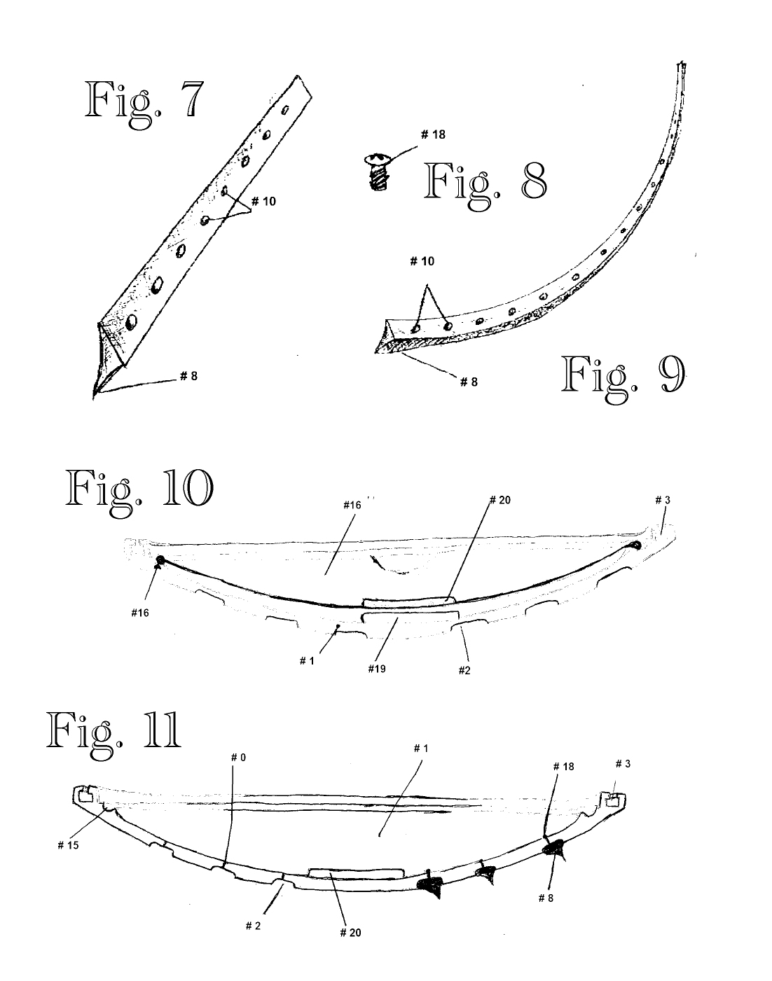

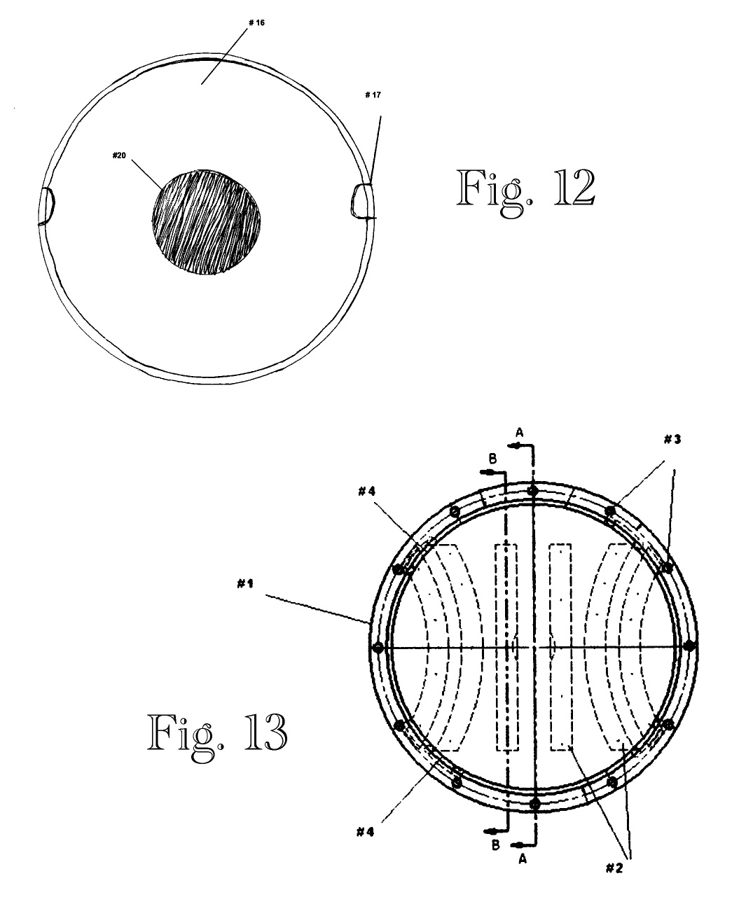

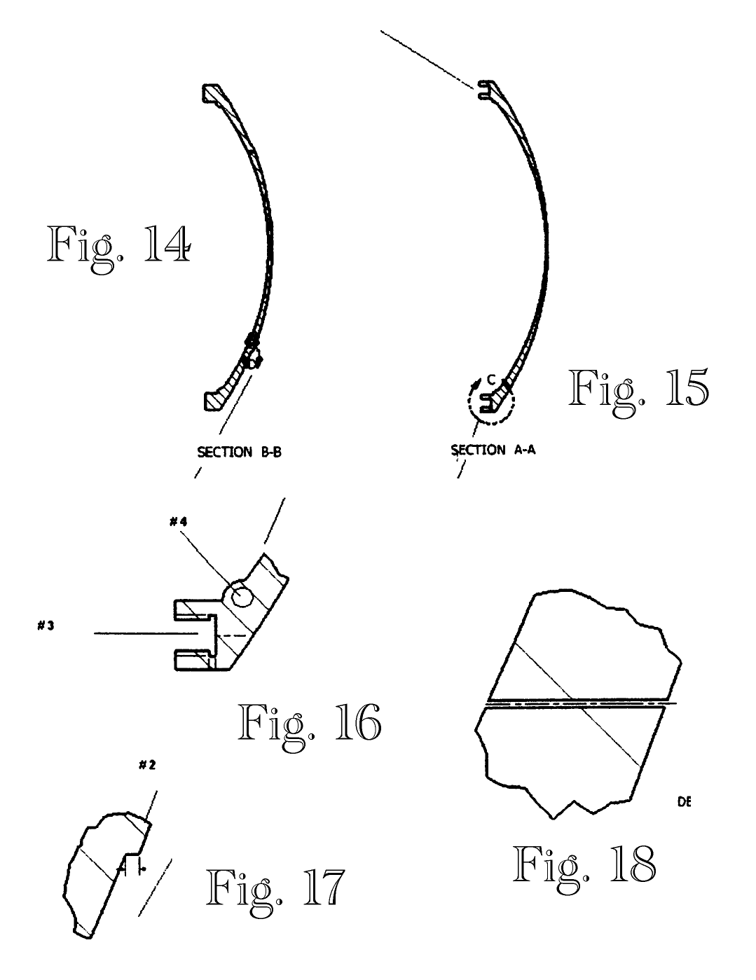

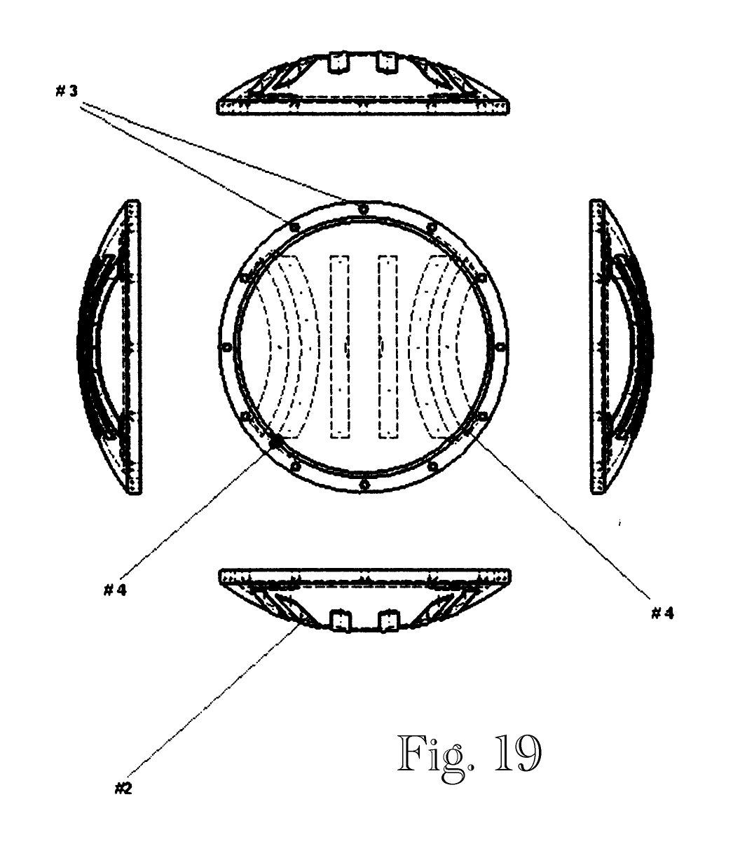

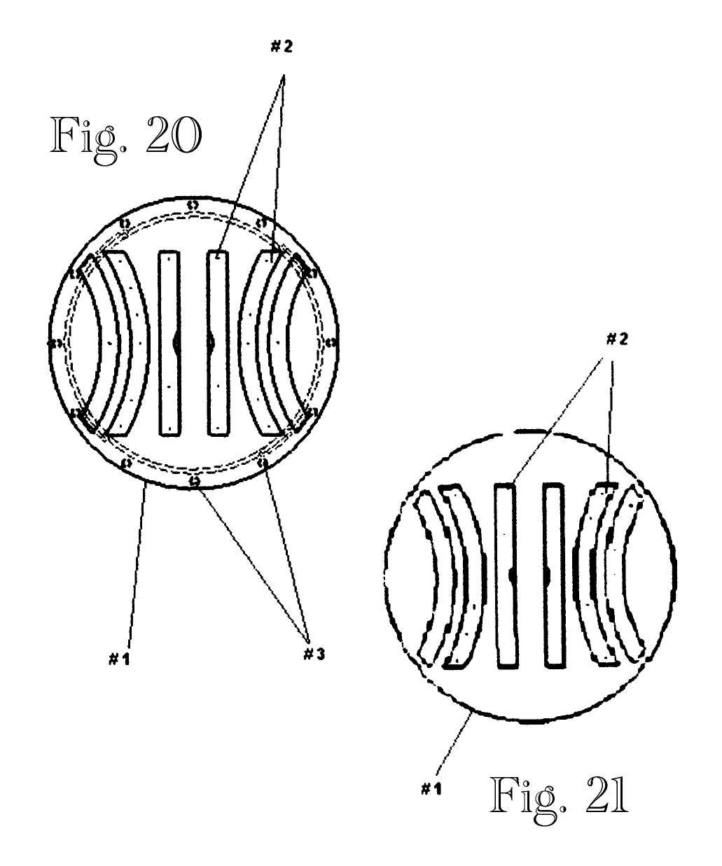

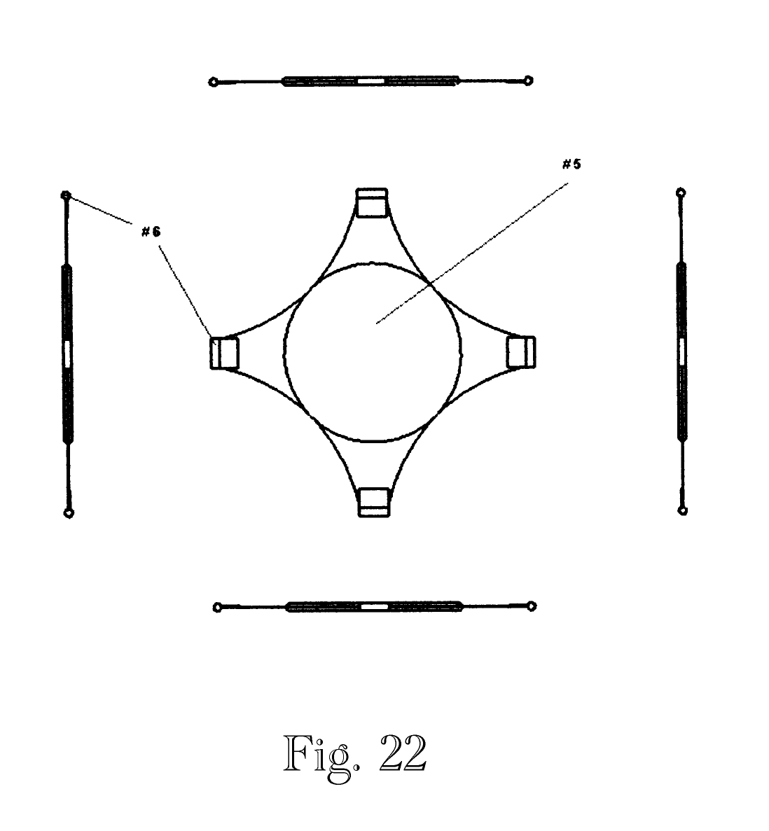

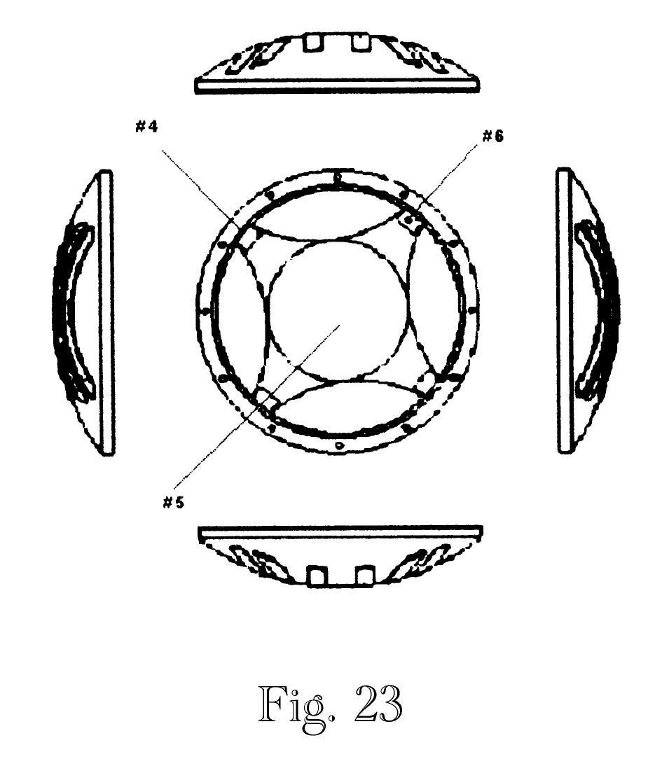

Reference will now be made in detail to some embodiments of the inventions, examples of which are illustrated in the accompanying drawings.

### DETAILED DESCRIPTION

Incorporated herein are elements of two exemplary sleds, by which sleds are created with additional maneuverability than ordinary sleds designed for use on the snow. Shown in the drawings are several of these elements, including the following:

| Reference number | Description |
|---|---|
| 0 | Holes in sled body for securing runners |
| 1 | Sled body |
| 2 | Grooves in sled body |
| 3 | Handle slots in sled body |
| 4 | Handle type 1 |
| 5 | Handle type 2 |
| 6 | Spring clip for securing handles |
| 7 | Detents for securing handles |
| 8 | Runners: metal inserts for sled grooves |
| 9 | Spike insert |
| 10 | Screw holes for mounting runners |
| 12 | “D” shaped handhold for handle type 1 |
| 13 | Handle shaft |
| 14 | Second optional handhold for handle type 1 |
| 15 | Support lip for inner liner in sled body |
| 16 | Removable inner liner |
| 17 | Removable handles for inner liner |
| 18 | Secure screws for metal runners |
| 19 | Removable cushion for sled body |
| 20 | Cusion for inner liner |

A sled as shown or described may permit easier manipulation and maneuvering, which may enable such a sled to be used at a higher speed, and for stunts and tricks. A sled body may take a form and size similar to circular sleds used by children, or it may be varied to accommodate persons of differing sizes and needs. A sled body may be made of many materials, and may be made of a light-weight metal or semi-rigid to rigid plastic. The examples shown incorporate a circular body, although other shapes can be used, for example oval, tear or egg shaped.

Ordinary sleds do not generally incorporate runners, but are usually made smooth on the bottom and are therefore not steerable. The exemplary sleds incorporate runners that protrude from the underside of the sled body, and are fitted thereto through the use of slots made in the body and fasteners, such as screws. The sleds shown in the drawings are somewhat larger in size than a standard sled to accommodate the runners. In an alternative designs, runners can be incorporated into the sled body itself, or as grooves therein; however if a sled body is made from plastic it may be desirable to use fastenable metal runners to resist abrasion from rocks and other objects that may be encountered. The runners may be made to be any length that provides substantial maneuverability and directional control. Runners may consist of a thin formed lightweight metal. The runners shown are formed to mate with the grooves of the sled, and secured by screws inserted through holes fashioned in the grooves of the sled body and there into the runners. The height of runners may be varied depending on the application put to the sled, as can the material or metal.

The grooves and/or runners may be designed at the center of the body to be substantially straight. Thus in a normal upright position these groves and/or runners make the most contract with the snow, and thereby provide a kind of keel keeping the sled oriented forward, or backward. In the examples, two grooves and runners are provided. Grooves and/or runners may be curved from the center of the sled body, which are higher on the sled body due to it's concave shape. Thus these curved grooves and/or runners avoid contacting the snow, or contact the snow less than the straight grooves and/or runners, when the sled is in an upright position. As the operator leans to the side, these curved runners and/or grooves more fully contact the snow, and thereby turning force is applied to the body of the sled. Grooves and/or runners placed further away from the center and curved at a sharper angle may permit sharper turns if the operator leans further from the upright position. Any of these grooves or runners may extend partially through the length of the sled body, providing less traveling resistance, or may extend substantially the full length of the sled body for improved control. The grooves and/or runners may be symmetrical if desires, thereby making a bi-directional stunt sled. Spikes, which may be cone-shaped, may also be incorporated to the far outsides of the sled body to act as brakes or to aid in very sharp turns.

Around the circumference of the exemplary sled bodies are holes or slots. These holes are adapted to receive handles, providing control over the roll or tilt of the sled body. Holes may be made equidistant to each other, but that is not necessary. These Handles may be secured by any means, for example by spring clips and/or detents as shown. The exemplary sled bodies incorporate several holes and thereby locations for securing handles, providing a user a choice of where control is effectuated. A handle may be inserted and secured in one hole (or for some handles holes), and later removed and secured in another hole and/or location. To remove the handles of the exemplary sleds, the clips are pressed in and the handles pulled straight out of their holes. The exemplary sled body and handles are designed to be easily separated and/or removed, although non-removable handles may also be utilized, if desired.

Two handle types are provided in the exemplary sleds. The first is a “D” shaped handle with a flat part grippable by the operator. The arch of the “D” may be fixed on top of a single shaft on which it can rotate. Below the “D” shaped hand hold there may be a second hand hold that is a short bar perpendicular to the handle shaft, which can also spin in place. The height of the handle may be varied to suit an operator's size and comfort.

A second handle type shown herein takes an upside-down “U” shape, curving up from one hole down to another in the sled body. The height, length, thickness and other factors may be varied to suit the needs of a particular individual or class, as desired. Likewise, other handle types than those described may be used in accordance with the principles described herein. Providing handles in a variety of shapes, sizes and heights may allow for a greater number of tricks or stunts and may also provide for use by different individuals.

Built into the rim of the exemplary sled bodies is an inner lip designed to support a removable liner. The liner may be made to be stiff, thereby absorbing shock by forcing the sled body to flex when an impact occurs, for example landing after becoming airborne. A liner may be designed to support the operator above the surface of the sled's body. One liner is fashioned from a fabric made of a strong material such as nylon or kevlar. The fabric is attached to a hoop that gives the liner it's shape, and also provides a grabbing area for the lip built into the inside of the sled body. The hoop of the liner may thereby snap into the lip inside the sled body. Small handles may also be provided in the liner's hoop to aid in removing it should that be desired. When the liner is inserted therein, the operator sits on the liner which may support him slightly above the surface of the sled body.

A cushion may be attached to or formed in a liner, which may also be placed in or near the center where the operator would sit or stand. The liner may be designed to support the operator and at the same time insulate him from shocks by forcing the sled body to flex. Thus the force of the operator's weight pushes down on the liner, and pulls the sled body inward, much like a bow flexing when the bow's string is pushed in rather than out. A cushion may provide support against the operator's weight against the sled bottom, if desired.

While the present devices, products and methods have been described and illustrated in conjunction with a number of specific configurations, those skilled in the art will appreciate that other variations and modifications may be made without departing from the principles herein illustrated, described, and claimed. The present invention, as defined by the appended claims, may be embodied in other specific forms without departing from its spirit or essential characteristics. The configurations described herein are to be considered in all respects as only illustrative, and not restrictive. All changes which come within the meaning and range of equivalency of the claims are to be embraced within their scope.

What is claimed is:

1. A vehicle for carrying a person over the snow, comprising:
a concave sled body sufficiently large to carry a person;
a set of grooves incorporated into said body;
runners fitted to said grooves, wherein at the center of said body said grooves and said runners are substantially straight, and further wherein away from the center said grooves and said runners are concave;
holes around the circumference of said body;
removable handles adapted to be securely fitted to said holes, where said handles are raised substantially above the sled body for controlling said vehicle through acrobatic stunts; and
a cushioning liner inside of said body.
